(19) United States
(12) Patent Application Publication
(10) Pub. No.: US 2025/0012760 A1
(43) Pub. Date: Jan. 9, 2025

(54) PIPELINE DEFECT DETECTION METHOD BASED ON MULTI-SENSING INFORMATION FUSION AND PIPELINE DEFECT POSITIONING METHOD BASED ON MULTI-SENSING INFORMATION FUSION

(71) Applicants: UNIVERSITY OF ELECTRONIC SCIENCE AND TECHNOLOGY, Chengdu (CN); SICHUAN DEYUAN PIPELINE TECHNOLOGY COMPANY LTD., Chengdu (CN)

(72) Inventors: Bin GAO, Chengdu (CN); HeWu XU, Chengdu (CN); Yupei YANG, Chengdu (CN); Liang SHEN, Chengdu (CN); Shiqiang JIANG, Chengdu (CN); Yong ZHANG, Chengdu (CN); Peng SUN, Chengdu (CN); Fei LUO, Chengdu (CN)

(21) Appl. No.: 18/710,573

(22) PCT Filed: Nov. 21, 2022
(86) PCT No.: PCT/CN2022/133311

§ 371 Date: May 15, 2024

(30) Foreign Application Priority Data
Nov. 19, 2021 (CN) 202111399961.0

(51) Int. Cl. G01N 27/90

(52) U.S. Cl. CPC G01N 27/90

(57) ABSTRACT

The present invention discloses a pipeline defect detecting and positioning method based on multi-sensor information fusion, which belongs to the technical field of pipeline non-destructive testing. The method comprises the following steps of performing state segmentation processing on a pipeline according to a pipeline defect detection signal and/or a three-axis attitude signal of a pipeline detection equipment in the pipeline, positioning a pipeline defect signal in the pipeline defect detection signal to a pipeline section in a corresponding state, and calculating a position of the pipeline defect signal in pipeline section in each state according to a running speed, the three-axis attitude signal, and mileage information of the pipeline detection equipment in the pipeline section in the corresponding state. According to the invention, the pipeline is segmented so that the pipeline defect can be preliminarily positioned in the pipeline section in a certain state.

### TECHNICAL FIELD

The present invention relates to the technical field of pipeline non-destructive testing, particularly to a pipeline defect detecting and positioning method based on multi-sensor information fusion.

### BACKGROUND

Pipelines are prone to develop defects such as cracking, corrosion, and deformation after years of use, which seriously affect their stability and reliability, and may even lead to accidents. Therefore, regular inspection of pipelines is essential to ensuring their effective running. A non-destructive testing technology, as a detecting method that does not damage the tested object, can guarantee the safe service of equipment structures and is one of the mainstream detection technologies nowadays.

Eddy current testing is a non-destructive testing method developed based on the electromagnetic induction theory. Its working principle is as follows: when an alternating current is applied to an excitation coil, an alternating magnetic field, referred to as a primary magnetic field, is generated around the excitation coil. When the alternating magnetic field approaches a conductor, the conductor generates induced eddy currents due to electromagnetic induction. These induced eddy currents, in turn, produce an induced magnetic field, referred to as a secondary magnetic field. The induced eddy currents are influenced by the magnetic permeability and electrical conductivity of the conductor. When defects are present, the eddy currents will be disturbed, affecting the secondary magnetic field. Therefore, the secondary magnetic field carries defect information, and effective detection of defects can be achieved by collecting an eddy current signal of the secondary magnetic field.

After detecting pipeline defects, it is necessary to accurately position them. Due to a complex internal environment inside the pipeline, visually positioning defect using instruments such as cameras is not feasible. Additionally, pipeline walls are usually made of metal, which has electromagnetic shielding effects, making it impossible to use GPS for accurate auxiliary positioning. Currently, commonly used defect positioning methods include mileage wheel-assisted positioning and a strapdown inertial navigation system. However, mileage wheels are prone to slipping or idling due to residual oil and other substances inside the pipeline, resulting in poor positioning accuracy. The strapdown inertial navigation system inherently accumulates errors over time, resulting in poor positioning accuracy over long distances of the pipeline. Therefore, achieving accurate positioning of pipeline defects is a pressing technical issue that needs to be addressed.

### SUMMARY

The present invention aims to overcome the issue of accurate positioning of a pipeline defect in the existing technology and provides a pipeline defect detecting and positioning method based on multi-sensor information fusion.

The purpose of the present invention is achieved through the following technical solutions: a pipeline defect positioning method based on multi-sensor information fusion, specifically including the following steps:

Performing state segmentation processing on a pipeline according to a pipeline defect detection signal and/or a three-axis attitude signal of a pipeline detection equipment, and positioning a pipeline defect signal in the pipeline detection signal to a pipeline section in a corresponding state.

Calculating a position of the pipeline defect signal in the pipeline section in each state according to a running speed, a three-axis attitude signal, and mileage information of the pipeline detection equipment in the pipeline section in the corresponding state.

In one example, the state segmentation processing includes establishing a weld seam discrimination model and/or a bend discrimination model.

The weld seam discrimination model determines whether the pipeline is in a weld seam section according to changes in a maximum principal component signal in the pipeline defect detection signal and/or changes in a z-axis acceleration signal in the three-axis attitude signal.

The bend discrimination model determines whether the pipeline is in a bend section according to changes in a yaw angle signal in the three-axis attitude signal.

In one example, the weld seam discrimination model performs weighted fusion processing on the maximum principal component signal and the z-axis acceleration signal to obtain a first fusion feature signal X(t), and performs anomaly detection processing on the first fusion feature signal to obtain a weld seam feature signal.

In one example, the determining whether the pipeline is in a bend section according to changes in a yaw angle signal in the three-axis attitude signal specifically includes:

Performing standard deviation processing and differential processing on the yaw angle signal to obtain a standard deviation signal and a differential signal.

Performing multiplication fusion processing on the standard deviation signal and the differential signal to obtain a second fusion feature signal.

Performing anomaly detection processing on the second fusion feature signal to obtain a bend feature signal.

In one example, before the establishing the weld seam discrimination model and/or the bend discrimination model, the method further includes performing sliding window processing on the maximum principal component signal in the pipeline defect detection signal, the z-axis acceleration signal in the three-axis attitude signal, and the yaw angle signal in the three-axis attitude signal, respectively.

In one example, the method further includes calculation steps for the three-axis attitude signal:

Collecting a three-axis acceleration signal and a three-axis angular velocity signal of the pipeline detection equipment.

Performing complementary fusion processing on the three-axis acceleration signal and the three-axis angular velocity signal to obtain the three-axis attitude signal, where the calculation formula for the complementary fusion processing is provided as follows:

$$\{ \begin{matrix}roll = {roll}_{acc} + ( {roll}_{acc} - {roll}_{gypo} ) \cdot k \\ pitch = {pitch}_{acc} + ( {pitch}_{acc} - {pitch}_{gypo} ) \cdot k \\ {yaw}_{n + 1} = {yaw}_{gypo}\end{matrix}$$

Wherein roll represents a roll angle signal in the three-axis attitude signal, roll_{acc} represents a roll angle acceleration signal, roll_{gypo} represents a roll angle angular velocity signal, k represents a proportionality coefficient, pitch represents a pitch angle signal in the three-axis attitude signal, pitch_{acc} represents a pitch angle acceleration signal, pitch_{gypo} represents a pitch angle angular velocity signal, yawₙ₊₁ represents a yaw angle signal in the three-axis attitude signal, and yaw_{gypo} represents a yaw angle angular velocity signal.

In one example, the running speed of the pipeline detection equipment in the pipeline section in different states is an average running speed, which is calculated according to the mileage information per unit time and/or a time difference between the same pipeline defect detection signal detected by two groups of detection probes in the pipeline detection equipment.

In one example, the calculation of the average running speed further includes:

Calibrating the average running speed based on the three-axis acceleration signal in the three-axis attitude signal to obtain a standard average operating speed.

It should be further noted that the technical features corresponding to the above examples can be combined or replaced with each other to form new technical solutions.

The present invention further includes a storage medium storing computer instructions thereon, where the computer instructions, when executed, perform the steps of the pipeline defect positioning method based on multi-sensor information fusion as described in any one or more of the above examples or combinations thereof.

The present invention further includes a terminal comprising a memory and a processor, where the memory stores computer instructions executable on the processor, and the processor, when executing the computer instructions, performs the steps of the pipeline defect positioning method based on multi-sensor information fusion as described in any one or more of the above examples or combinations thereof.

The present invention further includes a pipeline defect detecting method based on multi-sensor information fusion, comprising the following steps:

Extracting an amplitude signal and a phase signal of the pipeline defect detection signal.

Adding phase correction offset parameters to the phase signal to perform fusion processing on the amplitude signal and the phase signal to obtain a fusion signal.

Detecting the pipeline defect according to the fusion signal.

In one example, the determination of the pipeline defect according to the fusion signal specifically includes:

Performing segmentation processing on the fusion signal according to different constant speeds during the collection of the pipeline defect detection signal, and adjusting lengths of fusion signal sequences in different sections.

Performing anomaly detection processing on the fusion signal in different section to obtain a pipeline defect signal.

It should be further noted that the technical features corresponding to the above examples can be combined or replaced with each other to form new technical solutions.

The present invention further includes a storage medium storing computer instructions thereon, where the computer instructions, when executed, perform the steps of the pipeline defect detecting method according to multi-sensor information fusion as described in any one or more of the above examples or combinations thereof.

The present invention further includes a terminal comprising a memory and a processor, where the memory stores computer instructions executable on the processor, and the processor, when executing the computer instructions, performs the steps of the pipeline defect detecting method according to multi-sensor information fusion as described in any one or more of the above examples or combinations thereof.

Compared with the prior art, the advantageous effects of the present invention are as follows:

(1) In one example, according to the present invention, the pipeline is segmented so that the pipeline defect can be preliminarily positioned in the pipeline section in a certain state, and the position of the defect in the pipeline section in the current state is further calculated according to the running speed, the attitude parameter signal, and the mileage information of the pipeline detection equipment in the pipeline section in the current state, and accumulated errors caused by defect positioning only according to the mileage information can be eliminated, thus achieving accurate positioning of the pipeline defect. Additionally, segmentation processing is performed on the pipeline to facilitate defect investigation. Furthermore, the method of the present invention is applicable to pipelines with different diameters, demonstrating strong versatility.

(2) In one example, automatic determination of the pipeline in different states can be achieved by establishing the weld seam discrimination model and the bend discrimination model, reducing the workload of defect positioning.

(3) In one example, classifying pipeline states according to the first fusion feature signal and the second fusion feature signal can significantly further improve the accuracy of pipeline segmentation.

(4) In one example, the sliding window processing can flexibly control the workload of data processing according to a detection speed of a pipeline detector, so that the workload of data processing can be reduced while the accuracy of data is ensured.

(5) In one example, the complementary fusion processing is performed on the three-axis acceleration signal and the three-axis angular velocity signal, so that accumulated errors in the three-axis acceleration signal and the three-axis angular velocity signal can be eliminated, ensuring the accuracy of three-axis attitude parameters.

(6) In one example, the average running speed is calculated according to the mileage information combined with the time difference between the same pipeline defect detection signal detected by two groups of detection probes in the pipeline detection equipment, and the average running speed is corrected, so that actual running conditions of the pipeline in the pipeline detection equipment can be more accurately simulated to obtain a more realistic standard average running speed, thereby achieving accurate positioning of the pipeline defect.

(7) In one example, the amplitude-phase fusion processing can correct the delay of the amplitude signal and the phase signal, reduce the impact of lift-off on defect detection, thereby more accurately characterizing the pipeline defect signal and achieving accurate defect detection.

(8) In one example, performing anomaly detection processing on the fusion signal in different sections can reduce the influence of different speeds on the fusion signal, effectively detecting outlier values, i.e., the pipeline defect signal.

### BRIEF DESCRIPTION OF THE DRAWINGS

The embodiments of the present invention are described in further detail below in conjunction with the accompanying drawings, which here are intended to facilitate a better understanding of the present application and form a part of the present application. Similar reference signs are used in the drawings to denote similar or identical parts. The illustrative embodiments and explanations provided herein are intended to explain the present application and do not constitute undue limitations on the present application.

FIG. 1 illustrates an equivalent circuit diagram of a differential structure detection probe in one example of the present invention.

FIG. 2 illustrates an equivalent detection circuit diagram of a detection probe without a specimen under a differential structure in one example of the present invention.

FIG. 3 illustrates an equivalent detection circuit diagram of a detection probe with a specimen under a differential structure in one example of the present invention.

FIG. 4 illustrates a trend diagram of the influence of lift-off change on the amplitude signal and the phase signal in one example of the present invention.

FIG. 5 illustrates a schematic comparison of defect detection effects among the amplitude signal, the phase signal, and the fusion signal in one example of the present invention.

FIG. 6 illustrates a schematic comparison of defect detection effects among the amplitude signal, the phase signal, and the fusion signal in another example of the present invention.

FIG. 7 illustrates a flowchart of the method in a preferred example of the present invention.

FIG. 8 illustrates an effect diagram of on-site pipeline defect detection in one example of the present invention.

FIG. 9 illustrates an effect diagram of on-site bend detection in one example of the present invention.

FIG. 10 illustrates an effect diagram of on-site pipeline weld detection in one example of the present invention.

### DETAILED DESCRIPTION

The technical solution of the present invention is clearly and completely described below in conjunction with the accompanying drawings. It is evident that the described embodiments are part of the present invention, not all embodiments. Based on the embodiments of the present invention, all other embodiments obtained by those skilled in the art without inventive work are within the scope of protection of the present invention.

In the description of the present invention, it should be noted that directions or positional relationships indicated by “center”, “up”, “down”, “left”, “right”, “vertical”, “horizontal”, “inner”, “outer” and the like are the directions or positional relationships according to the accompanying drawings, which is only to facilitate the description of the present invention and simplifying the description, rather than indicating or implying that the device or component referred to must have a specific orientation, be constructed and operated in a specific orientation. Therefore, it should not be understood as a limitation on the present invention. In addition, the terms “first” and “second” are used for descriptive purposes only and should not be construed as indicating or implying relative importance.

In the description of the present invention, it should be noted that unless otherwise specified and limited, the terms “installation”, “connection”, and “linkage” should be broadly interpreted. For example, it can be a fixed connection, a detachable connection or an integrated connection, a mechanical connection or an electrical connection, a direct connection or an indirect connection through an intermediate medium, and a connection inside two components. For those skilled in the art, the specific meanings of the above terms in the present invention can be understood according to specific situations.

Furthermore, the technical features involved in the different embodiments of the present invention described below can be combined with each other as long as they do not conflict with each other.

The present invention further describes the technical solution based on the idea of segmenting the pipeline and calculating the defect position in the corresponding pipeline section to eliminate the accumulated errors in mileage based on a single mileage signal in the prior art, thereby improving the accuracy of the pipeline defect detection. The technical solution of the present application is described below.

In one example, the pipeline defect positioning method based on multi-sensor information fusion includes the following steps:

S11: Performing state segmentation processing on a pipeline according to a pipeline defect detection signal and a three-axis attitude signal of a pipeline detection equipment in the pipeline, and positioning the pipeline defect signal in the pipeline defect detection signal to a pipeline section in a corresponding state; wherein the pipeline defect detection signal refers to an original detection signal containing the pipeline defect signal obtained through existing pipeline defect detection means, such as the pipeline defect detection signal of the tested pipeline collected via an eddy current collector, and the pipeline defect signal represents a signal used to characterize the pipeline defect within the pipeline defect detection signal. The pipeline detection equipment is a detection equipment (an internal detector) used to detect the pipeline defect such as corrosion and deformation in the pipeline, such as a pipeline non-destructive testing equipment disclosed in a patent application for invention with the application No. 202110930910X, which is equipped with an eddy current sensor for collecting a pipeline defect detection signal, a mileage detector for collecting a self-operating mileage signal, and an attitude information collector for collecting self-attitude information. The three-axis attitude signal refers to a pitch angle signal, a roll angle signal, and a yaw angle signal of the pipeline detection equipment within the pipeline. In this example, the pipeline state segmentation processing involves dividing the pipeline into multiple sections according to different pipeline states, including straight pipeline sections, bend pipeline sections, and weld seam sections, to preliminarily position the pipeline defect in the pipeline section in the corresponding state.

S12: Calculating the position of the pipeline defect signal in the pipeline section in each state according to the running speed, the three-axis attitude signal and the mileage information of the pipeline detection equipment in the pipeline section in the corresponding state. As an option, the mileage information of the pipeline section in different states can be corrected in combination with pipeline design drawings. In this step, defect positioning is performed in the pipeline section in different states, and the running time of the pipeline detection equipment in the pipeline section in different states is only a few seconds or tens of seconds, thereby eliminating accumulated mileage errors and running speed errors of the pipeline detection equipment to achieve accurate positioning of the pipeline defect.

Furthermore, before performing the state segmentation processing on the pipeline according to the pipeline defect detection signal and the three-axis attitude signal of the pipeline detection equipment in the pipeline in step S11, the method further includes the following steps:

Performing correspondence on a time axis of the pipeline defect detection signal and the three-axis attitude signal, so that the pipeline defect detection signal and the three-axis attitude signal share the same time axis to achieve signal synchroization processing, and accurately positioning the pipeline defect signal to the pipeline section in the corresponding state.

In one example, the state segmentation processing includes establishing a weld seam discrimination model and a bend discrimination model. Due to complex running conditions of the pipeline detection equipment within the pipeline and interference from multiple factors such as residual impurities in the pipeline, different dynamic air pressures, and wear of the internal detector after multiple runs, it is challenging to establish models using supervised learning. Therefore, this application adopts unsupervised learning combined with data statistics (anomaly detection processing) to train and establish models.

Specifically, the weld seam discrimination model determines whether the pipeline is in a weld seam section according to changes in a maximum principal component signal of the pipeline defect detection signal and changes in a z-axis acceleration signal in the three-axis attitude signal. Moreover, two weld seam discrimination methods are used to determine the pipeline state, ensuring the accuracy of pipeline segmentation. Generally, pipeline welds are ring welds, so for a set of eddy current probes (eddy current sensors), changes in the eddy current signal (the pipeline defect detection signal) can be detected simultaneously on all sensors, serving as a feature signal for identifying welds. Additionally, since welds typically cause unevenness in pipe walls, the detector experiences vibration when passing through weld seams, resulting in changes in the z-axis acceleration signal. Therefore, the z-axis acceleration signal can also serve as a feature signal for weld seams.

Furthermore, the bend discrimination model determines whether the pipeline is in a bend section according to changes in the yaw angle signal in the three-axis attitude signal. For pipeline bends, there is a significant change in the yaw angle, which can serve as one of the features for identifying bends. Optionally, due to compression of the pipe walls against probes on the inside of the bend during bending, effectively changing the lift-off of the probes, changes in a signal can also occur on individual channels of the eddy current signal, which can also serve as a feature signal for bends.

In this example, automatic determination of the pipeline in different states can be achieved by establishing the weld seam discrimination model and the bend discrimination model, reducing the workload of defect positioning.

In one example, the weld seam discrimination model performs weighted fusion processing on the maximum principal component signal and the z-axis acceleration signal to obtain a first fusion feature signal X(t), and performs anomaly detection processing on the first fusion feature signal to obtain a weld seam feature signal. Specifically, the maximum principal component signal reflects the majority of information in the original eddy current signal (the pipeline defect detection signal), mainly representing a normal signal (corresponding to a straight pipeline section signal) and a weld signal. Additionally, since the z-axis acceleration signal is affected by gravity and is normally stable at −10 m/s², the value of the z-axis acceleration signal is first uniformly increased by 10 to eliminate the influence of gravity, and then squared to further increase the contrast between the normal signal (corresponding to the z-axis acceleration signal of the straight pipeline section) and the z-axis acceleration signal at the weld seams. Further weighted processing of the maximum principal component signal and the z-axis acceleration signal yields the first fusion feature signal X(t) that can characterize the weld seams.

$$X ( t ) = {Amp}_{pca} ( t ) + k * {( {a}_{z} ( t ) - 10 )}^{2}$$

Wherein Amp_{pca}(t) represents a maximum principal component signal obtained by PCA processing of the pipeline defect detection signal, a_{z}(t) represents an acceleration signal of the Z-axis, with the unit of m/s², k is a coefficient factor, which in this example is taken as 0.03.

More specifically, the anomaly detection processing in this example involves comparing all pipeline defect detection signals against a standard threshold. If a signal exceeds this threshold, it is marked as an anomaly, that is, a weld feature signal. Specifically, in this example, a frequency distribution histogram of the first fusion feature signal X(t) is obtained, and a Kolmogorov-Smirnov (K-S) test is performed on it to ensure that the distribution of the first fusion feature signal X(t) follows a normal distribution. Since the first fusion feature signal X(t) only contains anomalies caused by the weld seams, the standard deviation of the first fusion feature signal X(t) is calculated based on this. A certain probability is then used to determine a range, and any signal exceeding this range is considered an anomaly caused by the weld seams. In this example, a standard judgment threshold of 3 times the standard deviation is adopted, where any first fusion feature signal exceeding 3 times the standard deviation is considered a weld signal.

The method of the present invention further includes a verification step. Specifically, pipeline data obtained under different scenarios are segmented, and the predicted results of the model are compared with the actual results to verify the effectiveness of the model. Similarly, this verification step can be used for subsequent defect detection and defect positioning steps to ensure the effectiveness of the method of the present invention.

In one example, the determination of whether the pipeline is in a bend section according to changes in the yaw angle signal in the three-axis attitude signal specifically includes:

S111: Performing rolling standard deviation processing and rolling difference processing on the yaw angle signal to obtain a rolling standard deviation signal and a rolling differential signal; wherein the rolling standard deviation signal represents a yaw angle signal being rolled within a certain window size (calculated every 100 points in this example), and the standard deviation of the data within the window is calculated each time. The rolling differential signal represents the yaw angle signal being rolled within a certain window size (calculated every 100 points in this example), and the difference of the data within the window is calculated each time.

S112: Performing product fusion processing on the rolling standard deviation signal and the rolling differential signal to obtain a second fusion feature signal.

S113: Performing anomaly detection processing on the second fusion feature signal to obtain a bend feature signal.

Furthermore, since the range of the yaw angle (heading angle) is (−180°˜180°), when the yaw angle approaches 180° (−180°), its value will overflow to −180° (180°), resulting in a range jump. Therefore, overflow prevention processing is required for the pitch angle signal. Additionally, in order to improve the contrast between the yaw angle signal of the bend section and the straight pipeline section, and to more clearly distinguish the yaw angle signal of the bend section from those of the straight pipeline section, the method further includes the following steps before step a):

Inputting the standard deviation signal and the differential signal into a hyperbolic tangent function, so that the pitch angle signal undergoes significant changes only when the pipeline detection equipment turns, thereby increasing the contrast with the normal state signal.

Furthermore, the calculation formula for performing product fusion processing on the rolling standard deviation signal and the rolling differential signal is:

S(t)=arctan(stdᵣₒₗₗ)*tan h(diffᵣₒₗₗ)

Wherein S(t) represents a second feature fusion signal, stdᵣₒₗₗ represents a rolling standard deviation signal, diffᵣₒₗₗ represents a rolling differential signal. For pipelines, bends occupy a very small proportion of the entire pipeline length, meaning that the distribution of bends is sparse compared to the overall distribution, and the points of distribution are far from the points of normal straight lines. From a statistical perspective, in the data space, if a region contains sparse points, indicating a low probability of data points falling into this region, then the points in this region are considered anomalies. In this example, a binary search tree is continuously established according to the magnitude of the signal (the second feature fusion signal). If the left subtree of the binary search tree is not empty, then all nodes on the left subtree have values less than the value of its root node; if the right subtree of the binary search tree is not empty, then all nodes on the right subtree have values greater than the value of its root node, and both the left and right subtrees of the binary search tree are binary search trees. Based on the binary search tree, the time series sequence is divided into many layers according to the magnitude of the values. Since anomalies are usually larger or smaller than normal values, obvious anomalies can be found in the first few layers (closer to the root of the binary search tree).

Furthermore, the pipeline is divided into straight pipeline sections, weld seam sections, and bend pipeline sections according to the first fusion feature signal and the second fusion feature signal, thus improving the efficiency and accuracy of pipeline segmentation.

In one example, the discriminative methods in the weld discrimination model and the bend discrimination model can be reverse-corrected in conjunction with the pipeline state (straight pipeline sections, bend pipeline sections and weld pipeline sections) annotated in the pipeline design drawing. In this example, reverse correction of the model is achieved through incremental learning. The incremental learning is a continuous learning process where we assume the model has learned the prior knowledge of the old tasks. When faced with new tasks and corresponding data, we use the prior knowledge learned from the old tasks to assist the learning of the new tasks, and then update the knowledge learned by the model. For the pipeline recognition model (the weld discrimination model, the bend discrimination model) in this example, if the pipeline state in the pipeline design drawing is different from the pipeline state recognized by the model, special training using different exception data (the first fusion feature signal, the second fusion feature signal) is conducted. While ensuring the accuracy of the model recognition, the parameters of the model are further optimized and integrated based on the exception data, and new learning models are added to ensure that the model is in a continuous learning iteration and has the learning ability for the changing complex pipeline state, ensuring the correctness of the recognition.

In one example, prior to the steps of establishing the weld seam discrimination model and the bend discrimination model, the method further includes the following steps:

Performing sliding window processing on the maximum principal component signal in the pipeline defect detection signal, the z-axis acceleration signal in the three-axis attitude signal, and the yaw angle signal in the three-axis attitude signal, respectively. Sliding window processing can control the length of the data sequence received by the current window. The number of points included in the window and the coverage rate of the window will affect the accuracy of subsequent method judgments. Therefore, the number of points included in the window and the coverage rate of the window are particularly important. As an example, when the pipeline detection equipment runs at a speed of less than 5 m/s, the window contains 10 points, with a coverage rate of 0.5. When the pipeline detection equipment runs at a speed of greater than 5 m/s, the window contains 6 points, with a coverage rate of ⅔. This can achieve good signal segmentation results and defect positioning effects. The specific sliding window processing process is as follows:

Sliding window processing of the time-domain signal is performed using a window length of 10 and a coverage rate of 0.5, the first window consists of points 1 to 10 of the time-domain signal, the next window should include the number of points from the previous window (coverage rate*window length), and then subsequent points are taken until the number of points within the window reaches the window length. Therefore, the second window consists of points 5 to 15 of the time-domain signal, and so on, to obtain multiple windows for the entire time sequence. Then, feature values are calculated for each data within each window. After sliding window processing, the length of the signal sequence is reduced to ⅕ of its original length while retaining the basic information. Statistical features in the time domain and frequency domain are calculated for each window to obtain the feature quantity of the original signal, such as the z-axis acceleration signal in the three-axis attitude signal. Sliding window processing can flexibly control the workload of data processing according to the detection speed of the pipeline detector, ensuring data accuracy while reducing data processing workload.

As a preferred example, in the weld seam discrimination process, sliding window processing is used to receive only the maximum principal component signal of the pipeline defect detection signal and the z-axis acceleration signal in the three-axis attitude signal, thereby separating the signals and focusing only on the effective signals that affect weld seam discrimination (the maximum principal component signal and the z-axis acceleration signal), thereby minimizing interference from redundant signals on the maximum principal component signal and the z-axis acceleration signal and ensuring the accuracy of weld seam discrimination. Similarly, the bend discrimination process only receives the yaw angle signal in the three-axis attitude signal.

In one example, before the sliding window processing step, the method further includes the following steps:

Performing z-score standardization on the maximum principal component signal of the pipeline defect detection signal, the z-axis acceleration signal in the three-axis attitude signal, the yaw angle signal in the three-axis attitude signal, and the original signal (the pipeline defect detection signal and the three-axis attitude signal) to obtain a signal with a mean of 0 and a variance of 1, i.e., a standardized signal.

$${X}_{norm} = \frac{X - {X}_{mean}}{std}$$

Wherein X represents a signal sequence, Xmean represents a mean value of the signal sequence, std represents a standard deviation of the signal sequence.

As a preferred option, the sliding window processing can be used as a preprocessing step for any signal processing step in this application, i.e., after the signal is collected by the sensor and processed through sliding window, further data analysis can be performed. Signals such as a mileage signal collected by an odometer, a three-axis attitude signal collected by an attitude information collector, and a pipeline defect detection signal collected by an eddy current sensor can all be used for pipeline segmentation, velocity calculation, and defect detection processes after sliding window processing.

In one example, the method further includes the step of calculating the three-axis attitude signal:

S121: Collecting the three-axis acceleration signal and the three-axis angular velocity signal of the pipeline detection device. In this example, the attitude information collector specifically includes an inertial sensor IMU, which includes a gyroscope (a angular velocity sensor) for collecting an angular velocity signal and an accelerometer for collecting an acceleration signal.

S122: Performing complementary fusion processing on the three-axis acceleration signal and the three-axis angular velocity signal to obtain the three-axis attitude signal. The calculation formula for complementary fusion processing is:

$$\{ \begin{matrix}roll = {roll}_{acc} + ( {roll}_{acc} - {roll}_{gypo} ) \cdot k \\ pitch = {pitch}_{acc} + ( {pitch}_{acc} - {pitch}_{gypo} ) \cdot k \\ {yaw}_{n + 1} = {yaw}_{gypo}\end{matrix}$$

Wherein roll represents a roll angle signal in the three-axis attitude signal, roll_{acc} represents a roll angle acceleration, roll_{gypo} represents a roll angle angular velocity signal; k represents a proportional coefficient, pitch represents a pitch angle signal in the three-axis attitude signal, pitch_{acc} represents a pitch angle acceleration signal, pitch_{gypo} represents a pitch angle angular velocity signal, yawₙ₊₁ represents a yaw angle signal in the three-axis attitude signal and yaw_{gypo} represents a yaw angle angular velocity signal.

Furthermore, step S121 specifically includes calculating the Euler angles (the yaw angle, the pitch angle, the roll angle) that measure the attitude of the pipeline detection equipment according to the three-axis acceleration signal. The attitude calculation in the present invention adopts the rotation sequence ZYX, which means that the initial orientation of the IMU coordinate system coincides with the geodetic coordinate system, and then rotates successively around its own Z, Y, X axes. Specifically, rotating y degrees around the Z axis of the IMU represents the yaw angle yaw, rotating p degrees around the Y axis of the IMU represents the pitch angle, and rotating r degrees around the X axis of the IMU represents the roll angle. Since the gravity acceleration sensed by the IMU remains unchanged during rotation around the Z-axis, it is not possible to calculate the yaw angle using the accelerometer alone. Therefore, the present application can perform complementary fusion using both the gyroscope and the accelerometer in the IMU to calculate the yaw angle. Specifically, through the derivation of the rotation matrix, we can obtain:

$$\{ \begin{matrix}roll = arctan ( \frac{{a}_{y}}{{a}_{z}} ) \\ pitch = - arctan ( \frac{{a}_{x}}{\sqrt{{a}_{y}^{2} + {a}_{z}^{2}}} )\end{matrix}$$

Wherein ax represents an acceleration signal along the x-axis, a_{y} represents an acceleration signal along the y-axis, and a_{z} represents an acceleration signal along the z-axis. The angular velocities around the three axes measured by the gyroscope can still be derived using the rotation matrix, and the relationship between a changing rate of the angular velocity required for attitude update and the gyroscope readings can be expressed as follows:

$$[ \begin{matrix}\frac{dr}{dt} \\ \frac{dp}{dt} \\ \frac{dy}{dt}\end{matrix} ] = [ \begin{matrix}1 & \frac{sin p \cdot sin r}{cos p} & \frac{cos r \cdot sin p}{cos p} \\ 0 & cos r & - sin r \\ 0 & \frac{sin r}{cos p} & \frac{cos r}{cos p}\end{matrix} ] \cdot [ \begin{matrix}{g}_{x} \\ {g}_{y} \\ {g}_{z}\end{matrix} ]$$

Wherein gₓ, g_{y} and g_{z} respectively represent the gravity along the x, y, z axes. The attitude angles of the IMU at time n are r, p, y and subsequently r+Δr, p+Δp and y+Δy for calculating the attitude at time n+1, where the changes can be obtained through the changing rate and sampling period, that is:

$$\{ \begin{matrix}Δ r = \frac{dr}{dt} Δ t \\ Δ p = \frac{dp}{dt} Δ t \\ Δ y = \frac{dy}{dt} Δ t\end{matrix}$$

By combining the above two equations, the attitude angles calculated by the gyroscope, namely the roll angle roll_{gyro}, the pitch angle pitch_{gyro}, and the yaw angle yaw_{gyro}, can be obtained.

Furthermore, in step S122, due to the fact that the accelerometer provides more accurate attitude only during static moments, while the gyroscope is sensitive to attitude changes during rotation, and the gyroscope itself has errors that accumulate over time, it is necessary to complementarily fuse the three-axis acceleration signal with the three-axis angular velocity signal to ensure the accuracy of the three-axis attitude parameters.

In one example, the running speed of the pipeline detection equipment in the pipeline section in different states is the average running speed, which is calculated according to the mileage information per unit time and the time difference between the same pipeline defect detection signal detected by two groups of detection probes in the pipeline detection equipment. In this example, the mileage information is collected through the mileage wheel integrated into the pipeline detection equipment. To ensure the accuracy of the eddy current sensor signal (the pipeline defect detection signal) collection, this application sets up a group of eddy current sensors in circular direction at the front and rear ends of the pipeline detection equipment, each group containing 10 eddy current sensors. The two groups of eddy current sensors are installed alternately, achieving comprehensive detection of the pipeline wall.

Specifically, for the mileage wheel, if the mileage per unit time is calculated, the speed per unit time is obtained, wherein S_{Odometer-wheel} represents a mileage measured by the mileage wheel, r_{Odometer-wheel} represents a radius of the mileage wheel, v_{Odometer-wheel} represents a speed obtained through the mileage wheel, and n represents a ratio of the total pulse count to the number of pulses required for one revolution of the mileage wheel. The parameters mentioned above have the following relationship:

$$\{ \begin{matrix}{S}_{Odometer - wheel} = 2 π n \cdot {r}_{Odometer - wheel} \\ {v}_{Odometer - wheel} = \frac{{S}_{Odometer - wheel}}{T}\end{matrix}$$

Since the eddy current sensor consists of front and rear probes, and the distance between the front and rear probes is fixed, the speed v_{eddy} can be calculated by measuring the time difference between the signals of the front and rear probes when the same feature such as a weld seam is detected. The specific formula for calculation is:

$${v}_{eddy} = \frac{d}{{t}_{back} - {t}_{front}}$$

Wherein d represents a distance between the front and rear probes of the eddy current sensor, while t_{back},t_{front} respectively denote the time when the signal is detected by the rear probe and the time when the same signal is detected by the front probe.

In this example, the speed v_{eddy} is used to calibrate the speed v_{Odometer-wheel}. If the speeds are consistent, any speed can be considered the running speed of the pipeline detection equipment. If the speed v_{Odometer-wheel} differs from the speed v_{eddy}, and the difference between them is less than a predefined speed threshold, then the speed v_{eddy} prevails; if the difference exceeds the predefined threshold, then the speed v_{Odometer-wheel} prevails. This is because if the pipeline detection equipment slips or spins freely in a bend section, the two sets of eddy current sensors on the equipment will not pass through the corresponding section of the pipeline in the normal time frame (usually a few seconds or even shorter). In such cases, the speed will be reduced significantly and the difference between the spped v_{eddy} and the speed v_{Odometer-wheel} exceeds the predefined speed threshold, the calculated v_{eddy} is abnormal. When this occurs, the speed v_{Odometer-wheel} prevails. Furthermore, if the pipeline detection equipment cannot pass through the corresponding section of the pipeline, the speed v_{eddy} cannot be calculated, and in this case, the spped v_{Odometer-wheel} is used directly for defect positioning. It is important to note that the predefined speed threshold is determined according to repeated empirical values.

Additionally, in one example, the calculation of the average operating speed further includes:

Performing calibration on the average running speed according to the three-axis acceleration signal in the three-axis attitude signal to obtain the standard average running speed. Specifically, the average speed (the average running speed) is verified according to the time taken by the pipeline detection equipment to pass through the current section of the pipeline, the acceleration information, and the mileage information. The specific calculation formula is:

$$\begin{matrix}{v}_{t} = {v}_{o} + at \\ v = ( {v}_{o +} {v}_{t} ) / 2 \\ s = {v}_{o} + 0.5 {at}^{2}\end{matrix}$$

Wherein vₜ represents a final velocity of the pipeline section in the current state, vₒ represents an initial velocity of the pipeline section in the current state, a represents an acceleration of the pipeline section in the current state, t represents a time taken by the pipeline section in the current state, v represents an average velocity passing through the pipeline section in the current state, and s represents a length (mileage) passing through the pipeline section in the current state.

In the above two examples, the average running speed is calibrated to more accurately simulate the actual running conditions within the pipeline detection equipment, to obtain a standard average running speed that is more in line with the actual conditions, and on this basis, the accurate positions of the pipeline defect can be achieved.

This example provides a storage medium storing computer instructions stored thereon, which has the same inventive concept as the pipeline defect positioning method based on multi-sensor information fusion as described in any one or more of the above examples or combinations thereof. When executed, these computer instructions perform the steps of the defect positioning method based on multi-sensor information fusion as described in any one or more of the above examples or combinations thereof.

Based on this understanding, the technical solution of this example essentially or in other words, the part that contributes to the prior art or the part of the technical solution, can be embodied in the form of a software product. The computer software product is stored in a storage medium, including several instructions to enable a computing device (such as a personal computer, server, or network device) to execute all or part of the steps of the methods described in various embodiments of the present invention. The aforementioned storage medium includes: USB drives, portable hard drives, Read-Only Memory (ROM), Random Access Memory (RAM), disks, or CDs, and various other media capable of storing program codes.

This embodiment further provides a terminal, which has the same inventive concept as the pipeline defect positioning method based on multi-sensor information fusion as described in any one or more of the above examples or combinations thereof. The terminal comprises a memory and a processor, where the memory stores computer instructions executable on the processor. When executed by the processor, these computer instructions perform the steps of the pipeline defect positioning method based on multi-sensor information fusion as described in any one or more of the above examples or combinations thereof. The processor can be a single-core or multi-core central processing unit, a specific integrated circuit, or one or more integrated circuits configured to implement the present invention.

The various functional units provided in the embodiments of the invention may be integrated in a single processing unit or may exist separately, or two or more units may also be integrated in a single unit.

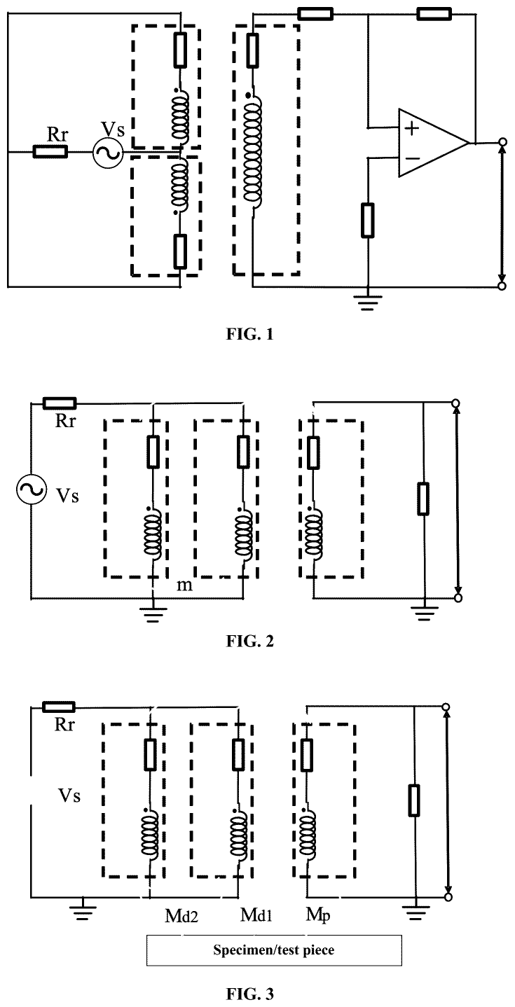

The invention further includes a defect detecting method based on multi-sensor information fusion, applied using a differential structure detection probe (an eddy current detector). The equivalent circuit diagram of the differential structure detection probe is shown in FIG. 1, including an excitation source, two parallel-connected excitation coils, two series-connected receiving coils, and an amplifier for amplifying a weak signal. The excitation source, i.e., the AC power supply, is connected to the other end of the excitation coils. The excitation coils are placed parallel to the receiving coils. One end of one receiving coil is connected to the same-direction input terminal of the amplifier through resistors R₂ and R₃, while the other end of the other receiving coil is connected to an output terminal of the amplifier. The reverse input terminal of the amplifier is grounded via a resistor R₅, and a feedback resistor R₄ is connected between the same-direction input terminal and the output terminal of the amplifier. The amplification factor of the amplifier is the ratio of R₄ to R₃.

Furthermore, an equivalent circuit diagram of the differential structure detection probe as shown in FIG. 1 is transformed to obtain an equivalent detection circuit of the differential structure detection probe without a specimen as shown in FIG. 2, and an equivalent detection circuit of the differential structure detection probe with a specimen (detected pipeline) as shown in FIG. 3. This allows for the analysis of the induced voltage values of the differential probe with and without the specimen. In FIGS. 2 2, R₁₁ and L₁₁ represent an excitation coil 1, R₁₂ and L₁₂ represent an excitation coil 2, R₂ and L₂ represent a receiving coil. Considering the mutual inductance m between the two excitation coils and the mutual inductance M between excitation and reception coils, the following formulas can be derived from Kirchhoff's law under air-coupled conditions:

$$\begin{matrix}{ε}_{1} ( j ω ) = - j ω {I}_{2} M \\ {ε}_{2} ( j ω ) = - j ω ( {I}_{11} - {I}_{12} ) M \\ {Z}_{11} {I}_{11} + j ω {I}_{12} m + ( {I}_{11} + {I}_{12} ) {R}_{r} - j ω {I}_{2} M = {V}_{s} \\ {Z}_{2} {I}_{2} - j ω ( {I}_{11} - {I}_{12} ) M = 0 \\ {Z}_{11} {I}_{11} + j ω {I}_{12} m = {Z}_{12} {I}_{12} + j ω {I}_{11} m\end{matrix}$$

In the above equation, I₁₁ and I₁₂ represent currents in the two excitation coils, Z₁₁=R₁₁+jωL₁₁ and Z₁₂=R₁₂+jωL₁₂ respectively represent the impedances of the two excitation coils, and the output voltage is solved as follows:

$${V}_{0} = {I}_{2} {R}_{L} = - \frac{{JMV}_{S} ( {Z}_{12} - {Z}_{11} ) {R}_{L}}{{Z}_{2} {Z}_{11} {Z}_{12} + ( {Z}_{12} + {Z}_{11} - 2 j ω m ) {R}_{r} {Z}_{2} + ( {Z}_{12} - {Z}_{11} + {Z}_{2} ) {ω}^{2} {M}^{2}}$$

When the two excitation coils are identical, their impedances are the same, and the output voltage is the differential signal, i.e., V₀=0. In addition, the excitation frequency does not linearly increase, and the optimal frequency needs to be determined through experiments and simulations. When a specimen is present, as shown in FIG. 3, the mutual inductance coefficient between the coils will change due to the eddy current effect of the specimen. If the probe is close to a defect, it will cause the imbalance of coil impedance, resulting in V₀ (the pipeline defect detection signal) not equaling zero.

The pipeline defect detecting method based on multi-sensor information fusion of the present invention performs detection on the pipeline defect based on the above eddy current detection probe (eddy current sensor), including the following steps:

S01: Extracting an amplitude signal and a phase signal of the pipeline defect detection signal; specifically, obtaining the amplitude signal and the phase signal according to the pipeline defect detection signal collected by the eddy current sensor.

S02: Adding phase correction offset parameters to the phase signal to realize fusion processing of the amplitude signal and the phase signal to obtain a fusion signal.

S03: Implementing the pipeline defect detection according to the fusion signal.

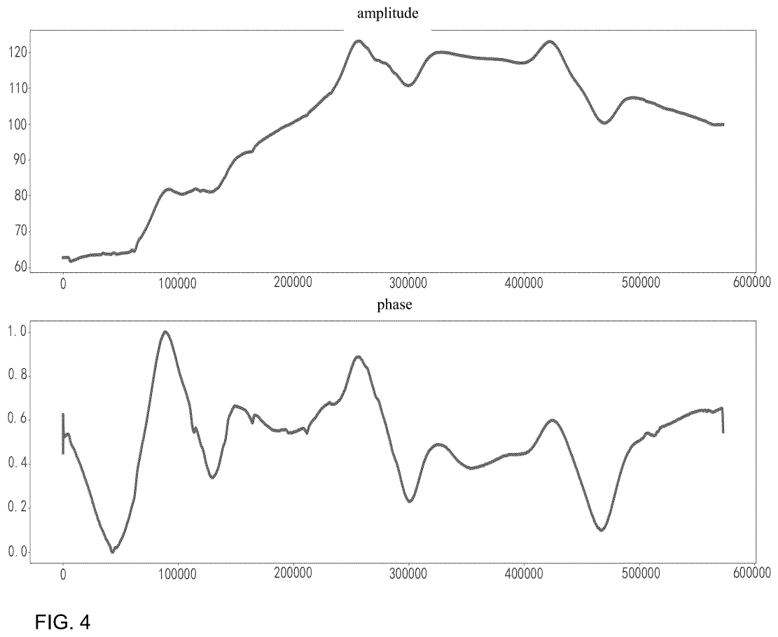

Specifically, the amplitude-phase fusion processing in step S02 is to reduce the influence of lift-off on defect detection. Specifically, the eddy current signal (the amplitude signal and the phase signal of the pipeline defect detection signal) is easily affected by many factors, among which lift-off has the greatest influence. Through extensive laboratory verification, it has been found that lift-off affects more the amplitude signal of the eddy current, while the influence on the phase signal is relatively small. Meanwhile, three defects are scanned with the detector, and the lift-off is continuously increased during the scan, where the scanning results are shown in FIG. 4. In FIG. 4, The horizontal axis represents a number of signal sampling points; a vertical axis of the amplitude (magnitude) signal of the defect detection signal represents a voltage value in mV, the vertical axis of the phase signal of the defect detection signal represents radians in rad. It can be seen from FIG. 4 that the amplitude signal fluctuates significantly, and the baseline drift trend is much larger than the trend caused by defect signals. Whereas for the phase signal, the baseline is relatively stable throughout the process, and the signal changes due to three defects are clearly visible. However, in the actual running of the internal detector (a pipeline detection equipment), it is not accurate to identify defects using only the phase signal. For some specific defects, the amplitude signal are much more sensitive to the changes than the phase signal. Therefore, this application adopts the method of fusing the amplitude signal and the phase signal, combining the advantages of both signals, so that the fusion signal can better represent the defect signal.

As is well known, time series signal y(t) can be expressed as:

$$y ( t ) = A . sin φ$$

Wherein A represents an amplitude and ϕ represents phase information.

However, in practical applications, there may be some delay in both the amplitude signal and the phase signal. Therefore, it is necessary to add a offset parameter α in the phase to correct the delay in the amplitude signal and the phase signal, in order to obtain a well-performing fusion signal for defect detection. The expression for the fusion processing is:

$$y ( t ) = A . sin ( φ + α )$$

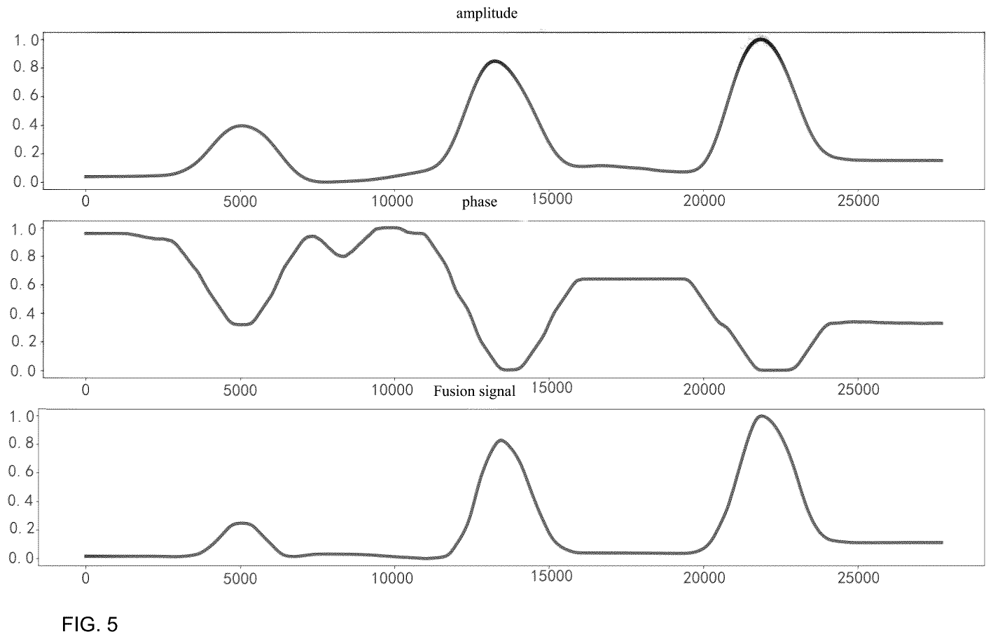

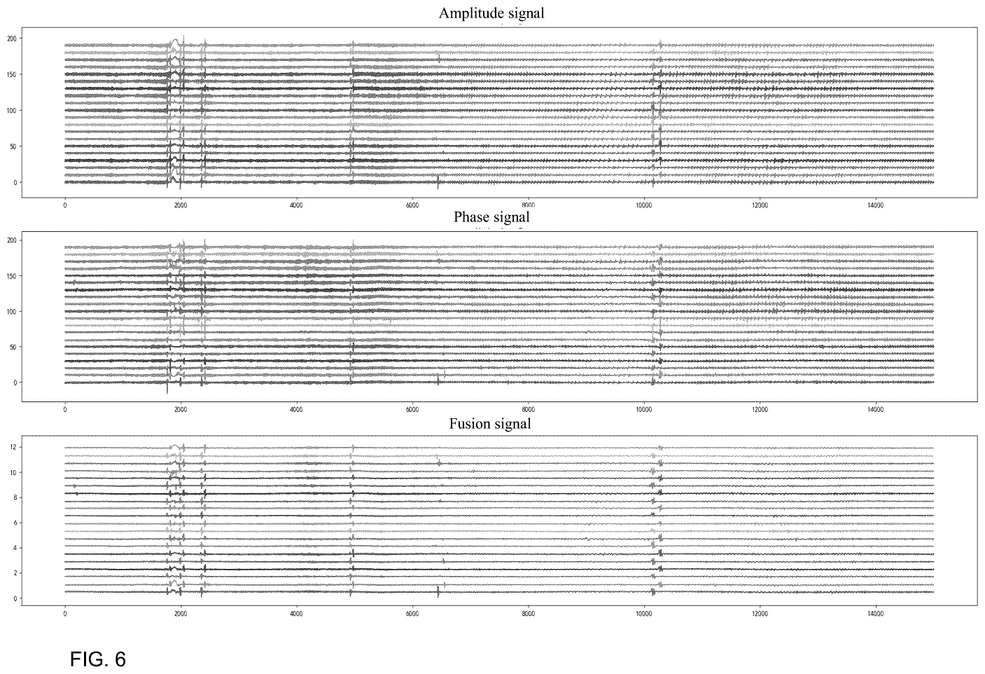

Through extensive experimentation, it has been verified that compared to monitoring pipeline defects based solely on the amplitude signal or the phase signal, the fusion signal can accurately reflect defects while also suppressing a large amount of noise, ensuring that the signals identified by the algorithm have good quality. FIGS. 5-6 show the comparison of the effects of the fusion signal, the amplitude signal and the phase signal. In FIG. 5, the comparison of the defect detection effects of the amplitude signal, the phase signal, and the fusion signal is shown, in which the horizontal axis represents the number of signal sampling points, and the vertical axis represents normalized values, used only to measure the degree of change. It can be observed that in the third subplot of FIG. 5, the fusion signal can identify three obvious defect signals and remains stable in non-defect signal regions, showing a significant improvement over the original signal. FIG. 6 illustrates the comparison of defect detection effects of the amplitude signal, the phase signal, and the fusion signal after expanding the detection data. In this figure, the horizontal axis represents the number of signal sampling points, and the vertical axis represents normalized values, with no units, indicating only the degree of change. In order to display 20 sets of data effectively in one image, an offset of 10 is added to each signal for both the amplitude signal and the phase signal, totaling 200 for the 20 sets. For the fusion signal, due to the smaller values obtained after nonlinear fusion, an offset of 0.6 is added to each signal, totaling 12. It can be observed from the third subplot that the fusion signal, compared to the amplitude signal and the phase signal, not only retains the defect signal but also greatly suppresses the jitter of the amplitude signal and the phase signal, providing a good precursor signal for subsequent defect signal identification.

In one example, the determining the pipeline defects according to the fusion signal includes:

S031: Performing segmentation processing on the fusion signal according to different constant speeds when collecting the pipeline defect detection signal, and adjusting lengths of the fusion signal in different sections. Specifically, different constant speeds represent the constant speeds at which the pipeline detection equipment runs during different time periods. That is, the pipeline detection equipment runs at a theoretical constant speed vₐ during the first time period and at a theoretical constant speed v_{b} during the second time period, and so on. Segmentation is performed on the fusion signal according to different constant speeds, to ensure that each segment of the signal can stably represent a certain distance of data when the speed varies. Furthermore, adjusting the lengths of the fusion signal sequences in different sections involves adjusting the number of points included in the sliding window processing of the fusion signal in different sections and the coverage rate of the window, thereby dynamically adjusting the length of the fusion signal sequence. For the fusion signal obtained when the pipeline detection equipment runs at a high speed (greater than 5 m/s), the window contains a small number of points and high coverage. Conversely, for the fusion signal obtained when the pipeline detection equipment runs at a slow speed (less than 5 m/s), the window contains a larger number of points and lower coverage. For example, when the pipeline detection equipment runs at a speed greater than 5 m/s, the fusion signal processing window contains 6 points with a coverage rate of ⅔. When the pipeline detection equipment runs at a speed less than 5 m/s, the window contains 10 points with a coverage rate of 0.5. This ensures that the fusion signal obtained at different speeds of the pipeline detection equipment have good resolution, ensuring the accuracy of defect detection.

S032: Performing anomaly detection processing on the fusion signal in different sections to obtain the pipeline defect signal. Specifically, anomaly detection processing involves first verifying the normal distribution of the fusion signal. If the distribution of the fusion signal demonstrates a normal distribution, the standard deviation of the signal in each section is calculated, and a probability is used to determine a range. Any signal exceeding this range is considered an anomaly caused by a defect. In this example, a judgment threshold of 5 times the standard deviation is adopted, and any signal exceeding 5 times the standard deviation is considered a defect signal, effectively detecting abnormal values, i.e., the pipeline defect signal.

This embodiment provides a storage medium storing computer instructions thereon, which has the same inventive concept as the pipeline defect detecting method based on multi-sensor information fusion as described in any one or more of the above examples or combinations thereof. When executed, these instructions perform the steps of the pipeline defect detecting method based on multi-sensor information fusion as described in any one or more of the above examples or combinations thereof.

Based on this understanding, the technical solution of this embodiment essentially or in other words, or the part that contributes to the prior art or the part of the technical solution, can be embodied in the form of a software product. The computer software product is stored in a storage medium, including several instructions to enable a computing device (such as a personal computer, server, or network device) to execute all or part of the steps of the methods described in various embodiments of the present invention. The above storage medium includes: USB drives, portable hard drives, Read-Only Memory (ROM), Random Access Memory (RAM), disks, or CDs, and various other media capable of storing program codes.

This embodiment further provides a terminal, which has the same inventive concept as the pipeline defect detecting method based on multi-sensor information fusion as described in any one or more of the above examples of combinations thereof. The terminal comprises a memory and a processor, where the memory stores computer instructions executable on the processor. When executed by the processor, these computer instructions perform the steps of the pipeline defect detecting method based on multi-sensor information fusion as described in any one or more of the above examples or combinations thereof. The processor can be a single-core or multi-core central processing unit, a specific integrated circuit, or one or more integrated circuits configured to implement the present invention.

The various functional units provided in the embodiments of the invention may be integrated in a single processing unit or may exist separately, or two or more units may also be integrated in a single unit.

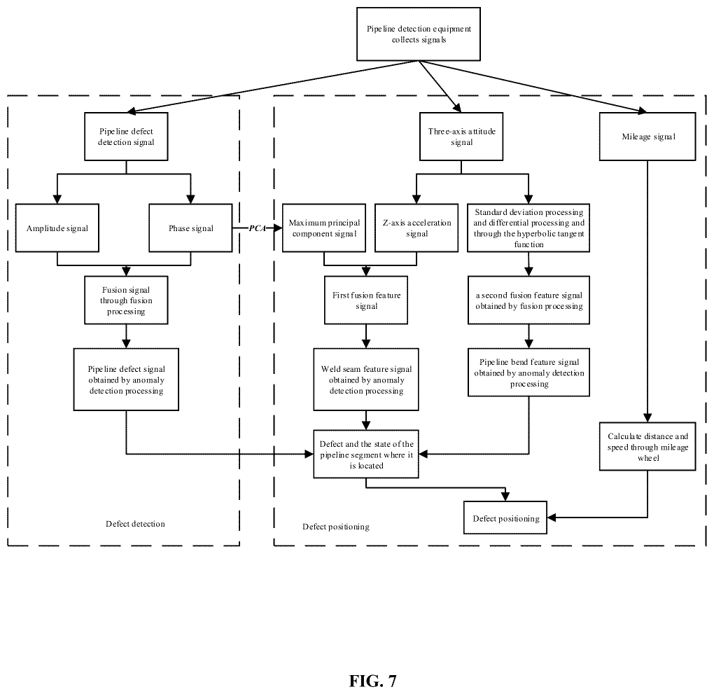

In one preferred example, combining defect detection and defect positioning from this application yields an optimal example, as shown in FIG. 7, specifically including the following steps:

S1: Collecting the pipeline defect detection signal, the three-axis attitude signal, and the mileage signal.

S2: Extracting the amplitude signal and the phase signal of the pipeline defect detection signal, adding phase correction offset parameters to the phase signal to realize fusion processing of the amplitude signal and the phase signal to obtain a fusion signal, and performing anomaly detection processing on the fusion signal to obtain the pipeline defect signal.

Where weighted fusion processing is performed on the maximum principal component signal and the z-axis acceleration signal to obtain the first fusion feature signal, and anomaly detection processing is performed on the first fusion feature signal to obtain a weld seam feature signal.

Standard deviation processing and differential processing are performed on the yaw angle signal to obtain a standard deviation signal and a differential signal, fusion processing is performed on the standard deviation signal and the differential signal using the hyperbolic tangent function to obtain a second fusion feature signal, and anomaly detection processing is performed on the second fusion feature signal to obtain a bend feature signal.

S3: Calculating the position of the pipeline defect signal in the pipeline section in each state according to the running speed of the pipeline detection equipment in the pipeline section in the corresponding state, the three-axis attitude signal, and the mileage information.

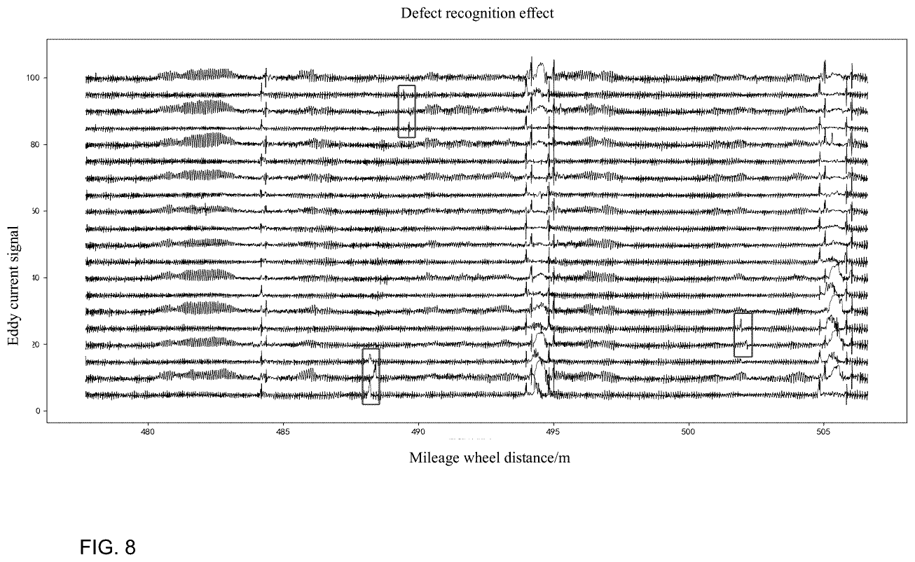

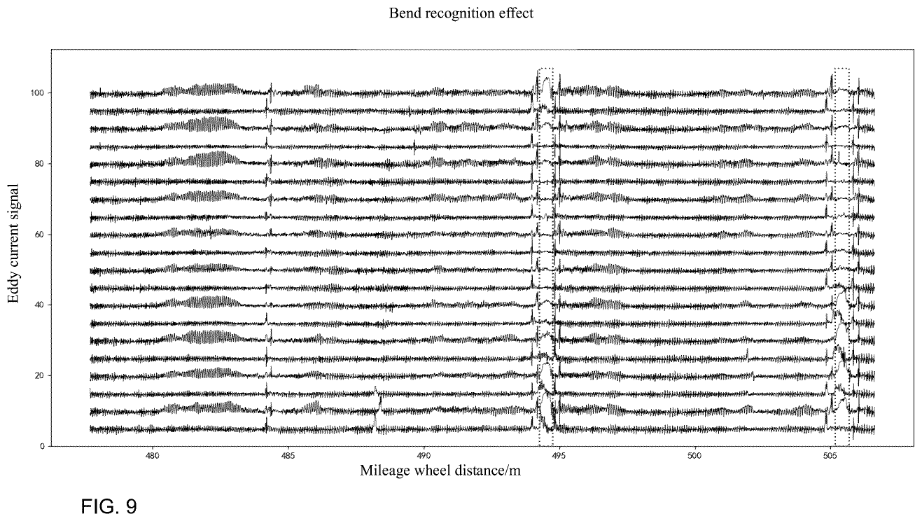

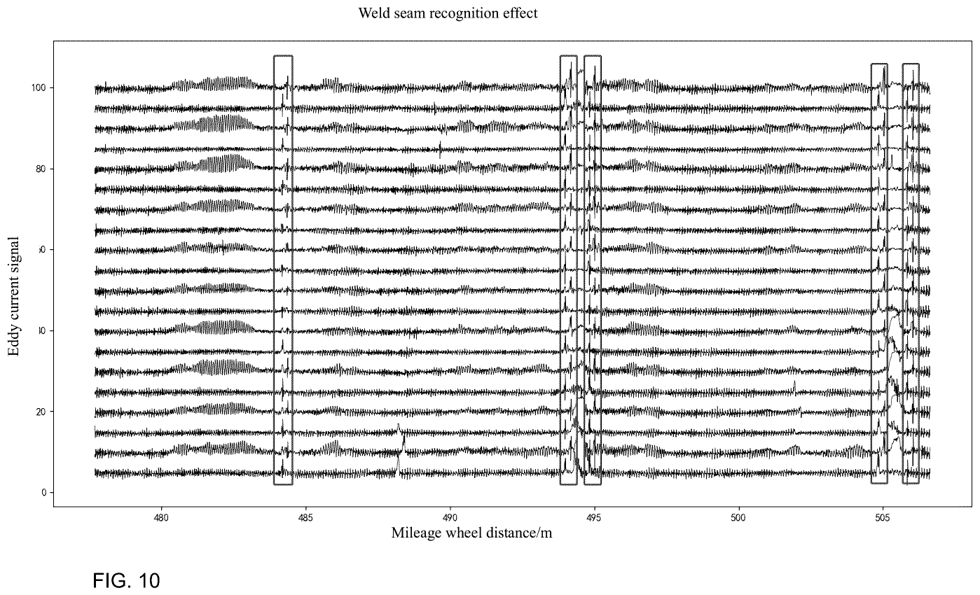

The detection effect diagram of the on-site pipeline defect obtained by the method described in the above examples is shown in FIG. 8, the detection effect diagram of the on-site pipeline bends is shown in FIG. 9, and the detection effect diagram of weld seams in the on-site pipeline is shown in FIG. 10. It can be seen therefrom that the waveform diagrams of defect detection, bend detection, and weld seam detection are relatively stable when compared with signals from previous moments. Any sudden signal changes are attributed to the pipeline defect signal, the weld seam signal, or the pipeline bend signal, effectively validating the effectiveness and reliability of the method of the present invention for the defect detection, weld seam detection, and bend detection.

The pipeline defect detection and positioning method based on multi-sensor information fusion of the present invention utilize a shared timeline for all signals. According to the timeline of the pipeline defect signal and the pipeline state, the defect signal can be preliminarily positioned in the pipeline section in a state. Then, the specific position of the defect relative to the pipeline section in each state can be calculated according to the mileage signal and the speed signal in the pipeline section in different states. Finally, the specific position of the defect in the pipeline can be determined by comparing with the line diagram of the pipeline. Compared to traditional defect detection and positioning methods, the defect detection obtained through multi-sensor information fusion performs better in handling complex pipeline environments. The entire model exhibits strong robustness, higher positioning accuracy and precision.

The present invention further includes a pipeline defect positioning system based on multi-sensor information fusion. The system comprises a pipeline detection equipment capable of moving with a medium inside the pipeline. The pipeline detection equipment integrates an eddy sensor for collecting the pipeline defect detection signal, a mileage detector for collecting running distance information of the pipeline detection equipment, an attitude information collector for collecting attitude information (the three-axis attitude signal) of the pipeline detection equipment, and a data processor for storing and/or processing data (such as the running distance information, the attitude information, the pipeline defect detection signal, etc.). The output terminals of the eddy sensor, the mileage detector, and the attitude information collector are all connected to the data processor.

As a preferred option, the data processor includes a first data processor and a second data processor. The first data processor is integrated into the pipeline detection equipment, preferably FPGA. The output terminals of the eddy current sensor, the mileage detector, and the attitude information collector are all connected to the I/O ports of the FPGA for data storage. The second data processor is a host computer. When data processing and analysis are required, particularly during pipeline defect positioning analysis, the FPGA is connected bidirectionally to the host computer located at the rear end. This connection facilitates the transfer of data such as the mileage information, the attitude information, and the pipeline defect detection signal from the FPGA to the host computer. The host computer then performs state segmentation processing on the pipeline according to the pipeline defect detection signal and/or the three-axis attitude signal of the pipeline detection equipment, and positions the pipeline defect signal in the pipeline defect detection signal to the pipeline section in the corresponding state. Additionally, according to the running speed, the three-axis attitude signal and the mileage information of the pipeline detection equipment in the pipeline section in the corresponding state, the host computer calculates the position of the pipeline defect signal in the pipeline section in each state. As an option, the host computer in the present invention system can execute the pipeline defect positioning method described in any of the above examples.

Alternatively, as an option, the first data processor, i.e., the FPGA, can serve as a main entity to execute the pipeline defect positioning method described in any of the above examples.

The present invention further includes a pipeline defect detection system based on multi-sensor information fusion. The system comprises a pipeline detection equipment capable of moving with a medium inside the pipeline. The pipeline detection equipment integrates an eddy current sensor for collecting the pipeline defect detection signal and a data processor for data processing. The output terminal of the eddy current sensor is connected to the data processor. As an option, the data processor includes a first data processor and a second data processor. The first data processor is integrated into the pipeline detection equipment, preferably FPGA, and the output terminal of the eddy current sensor is connected to the I/O ports of the FPGA for data storage. The second data processor is a host computer. When data processing and analysis are required, particularly during pipeline defect detection analysis, the FPGA is connected bidirectionally to the host computer located at the rear end. This connection facilitates the transfer of data such as the pipeline defect detection signal to the host computer. The host computer extracts the amplitude signal and the phase signal of the pipeline defect detection signal, adds phase correction offset parameters to the phase signal to achieve fusion processing of the amplitude signal and the phase signal, and performs pipeline defect detection according to the fusion signal.

Additionally, as an option, the first data processor, i.e., the FPGA, can serve as a main entity to execute the pipeline defect positioning method described in any of the above examples.

In one example, the data processor (host computer or FPGA) further performs segmentation processing on the fusion signal according to different constant speeds during the collection of the pipeline defect detection signal and adjusts the lengths of the fusion signal sequence in different sections. The data processor further performs anomaly detection processing on the fusion signal in different sections to obtain the pipeline defect signal.

The present invention further includes a pipeline defect detection and positioning system based on multi-sensor information fusion. The system comprises a pipeline detection equipment capable of moving with a medium inside the pipeline. The pipeline detection equipment integrates an eddy current sensor for collecting the pipeline defect detection signal, a mileage detector for collecting the running distance information of the pipeline detection equipment, an attitude information collector for collecting attitude information (the three-axis attitude signal) of the pipeline detection equipment, and a data processor for data processing. The output terminals of the eddy current sensor, the mileage detector, and the attitude information collector are all connected to the data processor. As an option, the data processor includes a first data processor and a second data processor. The first data processor is integrated into the pipeline detection equipment, preferably FPGA, and the output terminal of the eddy current sensor is connected to the I/O ports of the FPGA for data storage. The second data processor is a host computer. When data processing and analysis are required, particularly during pipeline defect detection analysis and/or pipeline defect positioning analysis, the FPGA is connected bidirectionally to the host computer located at the rear end. This connection facilitates the transfer of data such as the pipeline defect detection signal to the host computer. The host computer, as a main entity executing the data processing method (pipeline defect detection and defect detection), performs the following data processing steps:

Extracting the amplitude signal and the phase signal of the pipeline defect detection signal.

Adding phase correction offset parameters to the phase signal to achieve fusion processing of the amplitude signal and the phase signal to obtain a fusion signal.

Performing pipeline defect detection according to the fusion signal.

Performing state segmentation processing on the pipeline according to the pipeline defect detection signal and/or the three-axis attitude signal of the pipeline detection equipment in the pipeline, and positioning the pipeline defect signal in the pipeline defect detection signal to the pipeline section in the corresponding state.

Calculating the position of the pipeline defect signal in the pipeline in each sate according to the running speed, the three-axis attitude signal and the mileage information of the pipeline detection equipment in the pipeline in the corresponding state.

Additionally, as an option, the first data processor, i.e., the FPGA, can serve as the main entity to execute the pipeline defect positioning method and/or pipeline defect detecting method described in any of the above examples.

As an option, the data processor of the system in the example can execute the pipeline defect detecting method and pipeline defect positioning method described in any of the above examples.

The specific embodiments described above provide detailed explanations of the present invention. However, it should be understood that the specific embodiments of the present invention are not limited to these explanations. For persons of ordinary skilled in the technical field to which the present invention belongs, various simple deductions and substitutions can be made, and should be considered as falling within the scope of protection of the present invention without departing from the concept of the present invention.

1. A pipeline defect positioning method based on multi-sensor information fusion, comprising the following steps:
Performing state segmentation processing on a pipeline according to a pipeline defect detection signal and/or a three-axis attitude signal of a pipeline detection equipment in the pipeline, and positioning a pipeline defect signal in the pipeline defect detection signal to a pipeline section in a corresponding state.
Calculating a position of the pipeline defect signal in the pipeline section in each state according to a running speed, the three-axis attitude signal, and the mileage information of the pipeline detection equipment in the pipeline section in the corresponding state.
Wherein the state segmentation processing includes establishing a weld seam discrimination model and/or a bend discrimination model.
The weld seam discrimination model determines whether the pipeline is in a weld seam section according to changes in a maximum principal component signal in the pipeline defect detection signal, and/or determines whether the pipeline is in the weld seam section according to changes in a z-axis acceleration signal in the three-axis attitude signal.
The weld seam discrimination model performs weighted fusion processing on the maximum principal component signal and the z-axis acceleration signal to obtain a first fusion feature signal X(t), and performs anomaly detection processing on the first fusion feature signal to obtain a weld seam feature signal.
And wherein the bend discrimination model determines whether the pipeline is in a bend section according to changes in a yaw angle signal in the three-axis attitude signal.
The determining whether the pipeline is in a bend section according to changes in a yaw angle signal in the three-axis attitude signal specifically includes:
Performing standard deviation processing and differential processing on the yaw angle signal to obtain a standard deviation signal and a differential signal.
Performing multiplication fusion processing on the standard deviation signal and the differential signal to obtain a second fusion feature signal.
Performing anomaly detection processing on the second fusion feature signal to obtain a bend feature signal.
A calculation formula for performing multiplication fusion processing on the standard deviation signal and the differential signal is:
S(t)=arctan(stdᵣₒₗₗ)*tan h(diffᵣₒₗₗ)
Wherein S(t) represents the second feature fusion signal, stdᵣₒₗₗ represents a rolling standard deviation signal, diffᵣₒₗₗ represents a rolling differential signal.

2. The pipeline defect positioning method according to claim 1, wherein, before the establishing a weld seam discrimination model and/or a bend discrimination model, the method further comprises:
Performing sliding window processing on the maximum principal component signal in the pipeline defect detection signal, the z-axis acceleration signal in the three-axis attitude signal, and the yaw angle signal in the three-axis attitude signal, respectively.

3. The pipeline defect positioning method according to claim 1, wherein the method further comprises calculation steps for the three-axis attitude signal:
Collecting a three-axis acceleration signal and a three-axis angular velocity signal of the pipeline detection equipment.
Performing complementary fusion processing on the three-axis acceleration signal and the three-axis angular velocity signal to obtain the three-axis attitude signal, wherein a calculation formula for the complementary fusion processing is:
$$\{ \begin{matrix}roll = {roll}_{acc} + ( {roll}_{acc} - {roll}_{gypo} ) \cdot k \\ pitch = {pitch}_{acc} + ( {pitch}_{acc} - {pitch}_{gypo} ) \cdot k \\ {yaw}_{n + 1} = {yaw}_{gypo}\end{matrix}$$
Wherein roll represents a roll angle signal in the three-axis attitude signal, roll_{acc} represents a roll angle acceleration signal, roll_{gypo} represents a roll angle angular velocity signal, k represents a proportional coefficient, pitch represents a pitch angle signal in the three-axis attitude signal, pitch_{acc} represents a pitch angle acceleration signal, pitch_{gypo} represents a pitch angle angular velocity signal, yawₙ₊₁ represents a yaw angle signal in the three-axis attitude signal and yaw_{gypo} represents a yaw angle angular velocity signal.

4. The pipeline defect positioning method according to claim 1, wherein the running speed of the pipeline detection equipment in the pipeline section in different states is an average running speed, and the average running speed is calculated according to the mileage information per unit time and/or a time difference between the same pipeline defect detection signal detected by two groups of detection probes in the pipeline detection equipment.

5. The pipeline defect positioning method according to claim 4, wherein calculation of the average running speed further comprises:
Calibrating the average running speed based on the three-axis acceleration signal in the three-axis attitude signal to and obtain a standard average running speed.
